(19) United States
(12) Patent Application Publication
(10) Pub. No.: US 2003/0104092 A1
(43) Pub. Date: Jun. 5, 2003

(54) Plastic sheet processing apparatus

(76) Inventor: Kunitsugu Suzuki, Tokyo (JP)

Correspondence Address: OBLON, SPIVAK, MCCLELLAND, MAIER & NEUSTADT, P.C., FOURTH FLOOR, 1755 JEFFERSON DAVIS HIGHWAY, ARLINGTON, VA, 22202, US

(21) Appl. No.: 10/307,477

(22) Filed: Dec. 2, 2002

(30) Foreign Application Priority Data
Dec. 3, 2001 (JP) 2001-368792

(51) Int. Cl. B29C 59/04

(52) U.S. Cl. 425/104; 425/363; 425/385

(57) ABSTRACT

A plastic sheet processing apparatus for cutting into a predetermined shape an elongated plastic sheet unwound from a roll includes a heating unit for heating the plastic sheet; an embossing unit for uniformly forming depressions on the heated plastic sheet at predetermined intervals; an antistatic agent application unit for applying an antistatic agent onto the embossed plastic sheet; and a sliding enhancing agent application unit for applying a sliding enhancing agent onto the embossed plastic sheet.

### BACKGROUND OF THE INVENTION

1. Field of the Invention

The present invention relates to an apparatus for processing a plastic sheet formed of, for example, PET (polyethylene terephthalate) and cutting the processed sheet.

2. Description of the Related Art

When a packaging container as shown in FIG. 2 is formed from a plastic sheet, a plastic sheet 1 as shown in FIG. 1 is prepared first. The sheet 1 has been cut in a shape corresponding to that of the desired packaging container. Grooves 102 are formed on the sheet 1, and the sheet 1 is bent along the grooves 102 to thereby complete the packaging container. The grooves 102 are called “lines for folding” or simply “creasing lines.” The creasing lines are formed by a process in which a member called a “creasing line-forming blade” is pressed against the sheet 1.

The raw material of such a packaging container and plastic bottles is a plastic sheet formed of thermoplastic resin such as PET (polyethylene terephthalate). Such a plastic sheet is shipped from a plastic manufacturer in the form of a roll of a long sheet. In an intermediate process, the sheet is cut into a sheet of predetermined shape (in general, a rectangular shape). In an automatic packaging machine, after formation of creasing lines, the sheet is cut to a shape corresponding to that of a packaging container to be formed. When packaging containers are shipped from a plant to end users (e.g., department stores, stationary shops, cosmetic companies), the packaging containers are shipped without being formed into their final shapes. That is, a plurality of cut sheets as shown in FIG. 1 are stacked and then shipped. Alternatively, as shown in FIG. 3, a sticking tab 103 of a cut sheet is bonded to a counterpart portion of the sheet to produce a semi-completed container, which is then flattened. A plurality of flattened semi-completed containers are stacked and shipped. In the former case, users must bond the sticking tab 103 of each cut sheet to the counterpart portion thereof to complete a container. Therefore, plastic containers are generally shipped in the form shown in FIG. 3. In either case, during transportation, the surface 101 of each plastic container (plastic sheet) may be rubbed by the surface of another plastic container and scratched. When the surfaces of plastic containers are scratched, the commercial value of the plastic containers drops. In order to avoid such a problem, a method of coating the plastic surface 101 may be employed. However, this method has a drawback in that plastic containers become opaque (or semi-transparent), thus making it difficult to view products placed in the containers.

In order to avoid the above problem, a method of inserting a thin sheet of paper between adjacent plastic sheets may be employed. However, this method has a drawback in that when plastic sheets are separated, the paper sheet must be removed, thus adding to labor requirements.

When a plurality of plastic sheets having a predetermined shape (e.g., sheets like celluloid sheets) are produced by a plastic sheet processing apparatus and stacked, they are difficult to separate from one another, because they adhere closely to one another. In order to solve this problem, there has been proposed a plastic sheet processing method which can reliably separate stacked sheets, one sheet at a time, and feed them to a working machine such as an automatic packaging machine (see Japanese Patent Application Laid-Open (kokai) No. 9-174768, entitled “Plastic Sheet Processing Method”). This patent publication discloses a plastic sheet processing apparatus as follows.

A plastic sheet unwound from a roll is passed through a curl removing process, an antistatic treatment process, a creasing line forming process, a sliding powder applying process, and a cutting process to thereby obtain a plurality of sheets, which are then stacked. Since an antistatic agent is applied to each sheet in the antistatic treatment process and a sliding powder is applied onto each sheet before cutting, the sheets can be separated, one sheet at a time, easily and reliably.

However, the disclosed method and apparatus cannot solve the problem of the surfaces of plastic sheets being scratched easily.

### SUMMARY OF THE INVENTION

An object of the present invention is to provide a plastic-sheet processing apparatus capable of producing plastic sheets of a predetermined shape, which sheets can be separated easily one sheet at a time, and are hardly scratched.

The present invention provides a plastic sheet processing apparatus for cutting into a predetermined shape an elongated plastic sheet unwound from a roll, comprising: a heating unit for heating the plastic sheet; an embossing unit for uniformly forming depressions on the heated plastic sheet at substantially constant intervals; an antistatic agent application unit for applying an antistatic agent onto the embossed plastic sheet; and a sliding enhancing agent application unit for applying a sliding enhancing agent onto the embossed plastic sheet.

The embossing unit may include a plasto roller having fine protrusions formed on a surface thereof; and a rubber roller to be paired with the plasto roller, the rubber roller having a surface layer formed of rubber.

When plastic sheets are produced by the apparatus of the present invention, a large number of depressions are uniformly formed on a surface of each sheet. Therefore, when the plastic sheets are stacked, a layer of air is formed between adjacent plastic sheets. That is, in the present invention, since fine, shallow depressions are uniformly formed on the surfaces of plastic sheets during the plastic-sheet processing step, the conventional problems; i.e., close adhesion of sheets and easy formation of scratches, can be solved. A roller unit for forming depressions is called an embossing unit, which consists of a plasto roller and a rubber roller. When a heated plastic sheet passes between the plasto roller and the rubber roller, fine depressions are formed uniformly. Plastic sheets manufactured by use of the apparatus and having fine depressions maintain transparency. Therefore, when a container is formed from the plastic sheet and a commodity is placed in the container, the commodity within the container can be seen from the outside via the container, as in the case of conventional transparent plastic containers.

### BRIEF DESCRIPTION OF THE DRAWINGS

Various other objects, features and many of the attendant advantages of the present invention will be readily appreciated as the same becomes better understood by reference to the following detailed description of the preferred embodiment when considered in connection with the accompanying drawings, in which:

FIG. 1 is a plan view of a plastic sheet having creasing lines for a packaging container;

FIG. 2 is a perspective view of a container fabricated from the plastic sheet of FIG. 1;

FIG. 3 is an explanatory view showing the shape of the container flattened for shipment in a stack;

FIG. 4 is a schematic diagram of a plastic-sheet processing apparatus according to the present invention;

FIG. 5 is a side view of an embossing unit (a view as viewed from one axial end of the unit);

FIG. 6 is a side view of a plasto roller of the embossing unit;

FIG. 7 is a perspective view of a plastic sheet having depressions formed by means of the embossing unit; and

FIG. 8 is a view showing an example shape of the plasto roller of the embossing unit (the rubber roller has the same shape).

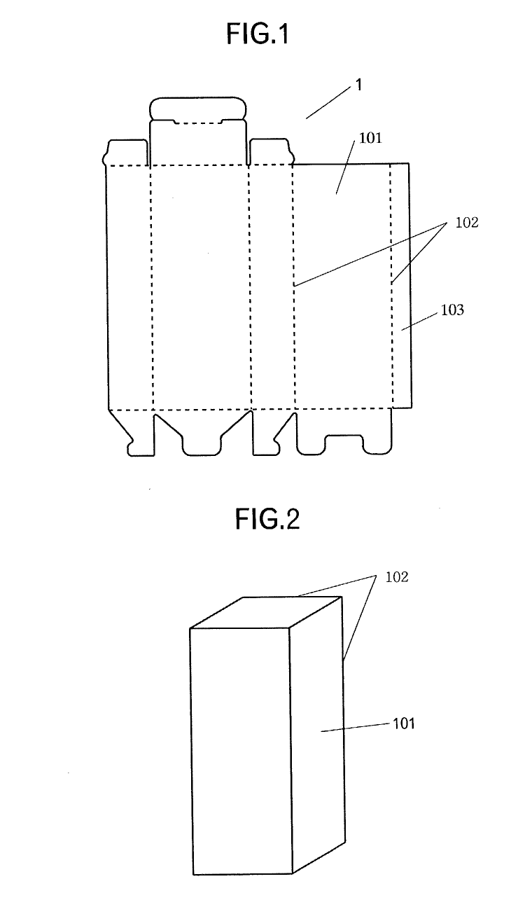

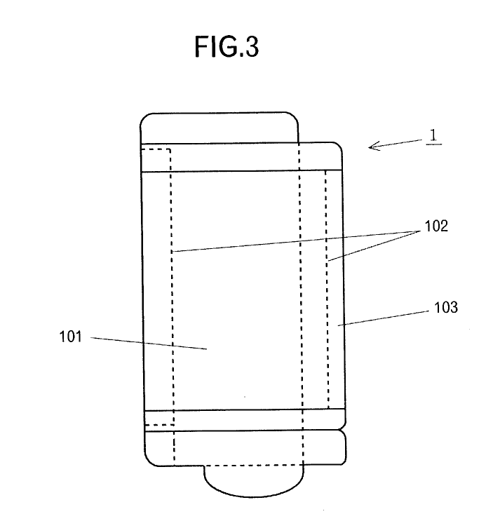

### DESCRIPTION OF THE PREFERRED EMBODIMENT

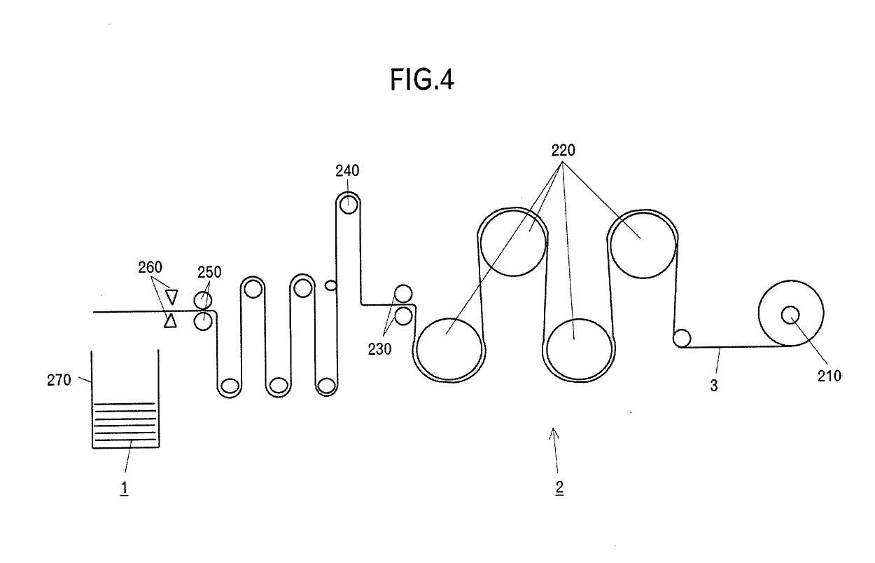

An embodiment of the present invention will be described with reference to the drawings. FIG. 4 shows a plastic-sheet processing apparatus 2 for producing plastic sheets having fine depressions. A plastic sheet to be used as a raw material (hereinafter referred to as a “material plastic sheet”) is formed of a thermoplastic resin such as PET (polyethylene terephthalate), PVC (polyvinyl chloride), or PP (polypropylene). A roll of an elongated material plastic sheet 3 is set onto a roller 210 and continuously fed to the interior of the apparatus 2. The material plastic sheet 3 is caused to travel around heating rollers 220 to thereby be heated. The heating rollers 220 are heated by heated oil supplied into the interiors thereof. In the illustrated example, the material plastic sheet 3 is caused to travel around four heating rollers 220. Before cooling down, the heated material plastic sheet 3 is passed through an embossing unit 230 in order to form fine depressions on the material plastic sheet 3. After passage through the embossing unit 230, the material plastic sheet 3 is caused to travel along a straight path, to thereby be cooled. Thus, curled portions are removed from the material plastic sheet 3 to thereby straighten and flatten the sheet. Further, an antistatic agent is applied to the material plastic sheet 3 by means of an antistatic agent application unit 240. An antistatic agent containing a predominant amount of a surfactant (cationic surfactant) may be preferably used. In the final stage, a sliding enhancing powder (powder for enhancing the sliding property of the sheet) is applied to the material plastic sheet 3 by means of a sliding enhancing powder application unit 250, and is then cut into a predetermined shape by means of a cutting unit 260. Thus-produced plastic sheets 1 are stacked in a stacker 270. Fine powder of starch coated with silicon may be used as the sliding enhancing powder.

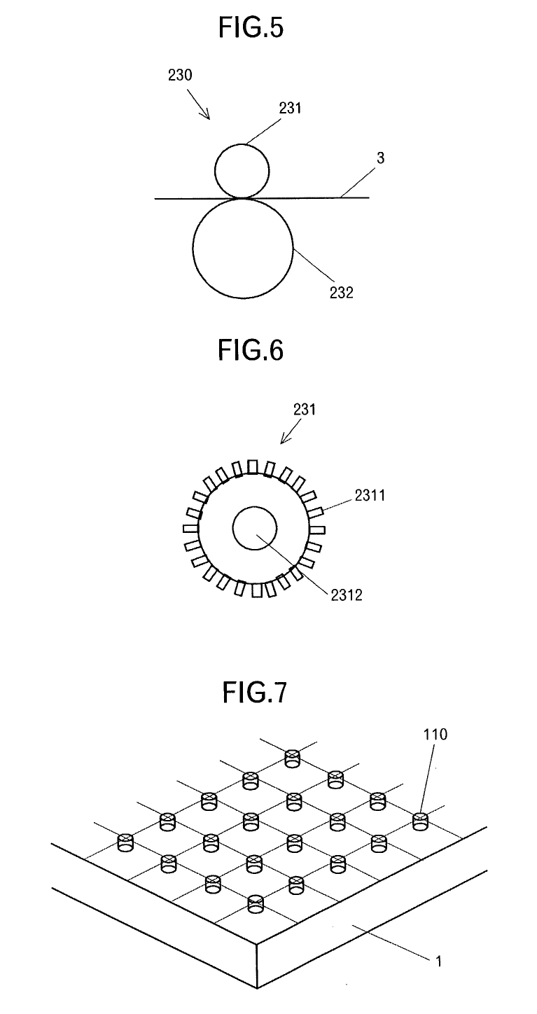

Next, the embossing unit 230, which plays the most important role in the present invention, will be described. As shown in FIG. 5, the embossing unit 230 includes a plasto roller 231 and a rubber roller 232. When the material plastic sheet 3 passes through between the two rollers, the plasto roller 231 forms fine depressions. FIG. 6 is a side view of the plasto roller 231 as viewed from one end of a rotary shaft 2312. A large number of projections 2311 each having a columnar shape are formed on the circumferential surface of the plasto roller 231. The projections 2311 form depressions on the material plastic sheet 3. As shown in FIG. 7, depressions 110 formed on the plastic sheet 1 (i.e., the material plastic sheet 3 shown in FIG. 4) by the embossing unit 230 are shallow and distributed uniformly at constant intervals. The projections 2311 shown in FIG. 6 and the depressions 110 shown in FIG. 7 are depicted in an exaggerated manner; in actuality, the depressions 110 are so shallow and small that the presence of individual depressions cannot be clearly perceived through visual observation. The depth and diameter of the depressions 110 are set in such a manner that a faint grid pattern can be observed when the material plastic sheet 3 is viewed as a whole, and a slightly rough texture can be sensed by the finger. Accordingly, the transparency of the material plastic sheet 3 is maintained substantially. Although the projections 2311 shown in FIG. 6 each have a circular cross section, they may have a rectangular or square cross section. The projections 2311 each have a height of 0.02 to 0.10 mm, preferably 0.04 to 0.08 mm, more preferably about 0.06 mm; and a cross sectional area of 0.01 to 0.09 mm², preferably 0.03 to 0.07 mm², more preferably about 0.05 mm² (about 0.22 mm×0.22 mm, in the case where the projections 2311 each have a square cross section). The projections 2311 are arranged on the circumferential surface of the plasto roller 231 at intervals of 0.1 to 0.7 mm, preferably 0.25 to 0.55 mm, more preferably about 0.4 mm. The fine depressions formed uniformly prevent close adhesion of stacked sheets to thereby enable easy separation of sheets and prevent formation of scratches, which would otherwise be formed due to mutual contact of the sheets.

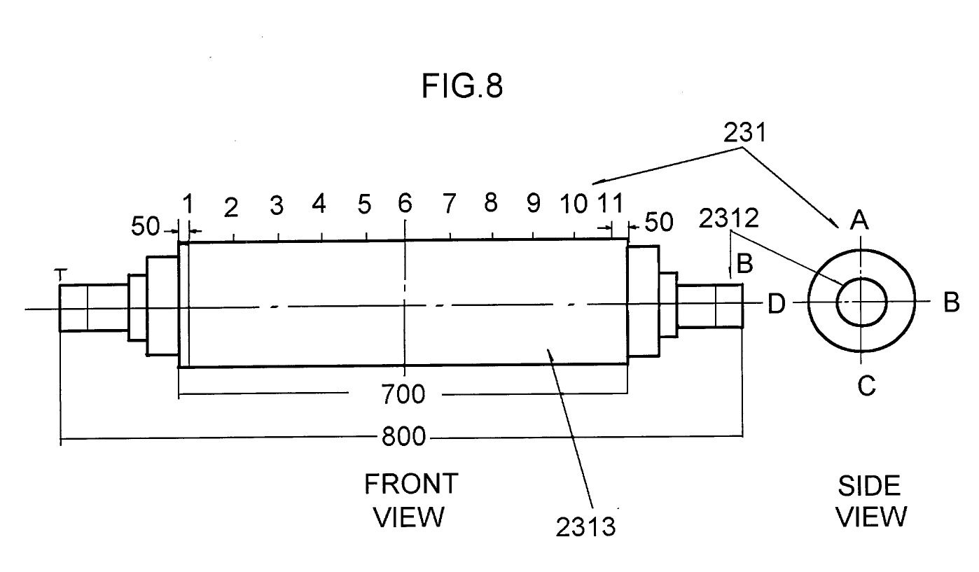

FIG. 8 shows an example shape of the plasto roller 231 (unit of dimensions: mm). The projections 2311 shown in FIG. 6 are uniformly distributed over the circumferential surface 2313 of the plasto roller 231. Although the rubber roller 232 has the same shape as that of the plasto roller 231, the rubber roller 232 is formed to be larger in diameter than the plasto roller 231, and no protrusions are formed on the circumferential surface of the rubber roller 232. The reason why uniform depressions are easily formed on the material plastic sheet 3 while the material plastic sheet 3 passes between the plasto roller 231 and the rubber roller 232 is that embossing is effected during a period in which the thermoplastic material plastic sheet 3 maintains high temperature.

The purpose of applying an antistatic agent to the material plastic sheet 3 is to prevent adhesion of dust to the plastic sheets 1, which adhesion would otherwise occur due to the buildup of static electricity in the plastic sheets 1, thereby dirtying the sheets. The purpose of applying sliding enhancing powder to the material plastic sheet 3 is to solve the problem which would otherwise occur in a working process of an automatic packaging container production machine due to close adhesion of stacked plastic sheets; specifically, to prevent the simultaneous feeding of two or more stacked plastic sheets. As compared with conventional plastic sheets to which sliding enhancing powder has been applied but in which no depressions are formed, the plastic sheets of the present invention having depressions can be separated, without fail, on a sheet-by-sheet basis. Further, the sliding enhancing powder prevents formation of scratches, which would otherwise occur due to sliding contact between sheets.

As described above, through formation of fine depressions on surfaces of plastic sheets, close adhesion of the plastic sheets can be prevented, along with formation of scratches, which would otherwise occur due to sliding contact between sheets when the plastic sheets are shipped in a stacked manner or are fed to a container forming stage. Since special coating as having been used conventionally is not required, the working process can be simplified. Further, since no special agents are used, extra cost is not required. In addition, since a special coating is not performed, the clearness of the material plastic sheet can be maintained.

Obviously, numerous modifications and variations of the present invention are possible in light of the above teachings. It is therefore to be understood that within the scope of the appended claims, the present invention may be practiced otherwise than as specifically described herein.

What is claimed is:

1. A plastic sheet processing apparatus for cutting into a predetermined shape an elongated plastic sheet unwound from a roll, comprising:
a heating unit for heating the plastic sheet;
an embossing unit for uniformly forming depressions on the heated plastic sheet at substantially constant intervals;
an antistatic agent application unit for applying an antistatic agent onto the embossed plastic sheet; and
a sliding enhancing agent application unit for applying a sliding enhancing agent onto the embossed plastic sheet.

2. A plastic sheet processing apparatus according to claim 1, wherein the embossing unit include:
a plasto roller having fine protrusions formed on a surface thereof; and
a rubber roller to be paired with the plasto roller, the rubber roller having a surface layer formed of rubber.
